(19) United States
(12) Patent Application Publication
(10) Pub. No.: US 2024/0353600 A1
(43) Pub. Date: Oct. 24, 2024

(54) IMMERSION DIFFRACTION ELEMENT AND METHOD FOR PRODUCING SAME

(71) Applicant: NIPPON ELECTRIC GLASS CO., LTD., Otsu-shi, Shiga (JP)

(72) Inventor: Mitsuru TOMITA, Otsu-shi (JP)

(21) Appl. No.: 18/683,534

(22) PCT Filed: Sep. 26, 2022
(86) PCT No.: PCT/JP2022/035576

§ 371 Date: Feb. 14, 2024

(30) Foreign Application Priority Data
Oct. 5, 2021 (JP) 2021-164117
Oct. 5, 2021 (JP) 2021-164119
Jul. 7, 2022 (JP) 2022-109880

(51) Int. Cl. G02B 5/18; B29D 11/00; G02B 1/02; G02B 1/10

(52) U.S. Cl. CPC G02B 5/1814; B29D 11/00769; B29D 11/00865; G02B 1/02; G02B 1/10; G02B 5/1847; G02B 5/1866

(57) ABSTRACT

Provided is an immersion diffraction element easily producible and capable of increasing the degrees of freedom in the design of a diffraction portion. An immersion diffraction element 1 includes a prism portion 2 and a diffraction portion 4, wherein the prism portion 2 and the diffraction portion 4 are made of amorphous glass.

### TECHNICAL FIELD

The present invention relates to immersion diffraction elements and methods for producing the immersion diffraction elements.

### BACKGROUND ART

Recently, attention has been focused on an immersion diffraction element enabling size reduction of a spectroscope and improvement in wavelength resolution as compared to a general reflective element. The immersion diffraction element has, for example, a structure in which a prism is provided with a diffraction portion. In the diffraction portion, a plurality of diffraction grooves are periodically provided. In spectrally separating light using an immersion diffraction element, light passes through the prism and is reflected and spectrally separated at the diffraction portion. Thereafter, the spectrally separated light is emitted from the prism.

When light passes through the prism, the wavelength of the light is 1/n where n represents the refractive index of the prism. Accordingly, the pitch of diffraction grooves necessary for spectral separation of light is 1/n. Therefore, even if the immersion diffraction element is reduced in size, it can be provided with a large number of diffraction grooves and can be increased in wavelength resolution.

Patent Literatures 1 and 2 below disclose diffraction gratings as examples of the immersion diffraction element. Patent Literature 1 discloses a diffraction grating in which a material of single-crystal Ge or single-crystal Si is used and grating grooves are formed in the (1 1 1) plane being a crystal orientation. Patent Literature 2 discloses a diffraction grating in which InP or InAs crystal material is provided with grating grooves. The grating grooves include the (1 1 0) plane as a crystal orientation of the crystal material.

### CITATION LIST

### Patent Literature

### [PTL 1]

JP-A-2003-75622

### [PTL 2]

JP-A-2015-121605

### SUMMARY OF INVENTION

### Technical Problem

However, in forming grating grooves in a crystal material as in Patent Literatures 1 and 2, the grating grooves are formed by subjecting the crystal material to cutting, etching or like processing. Therefore, there is a problem of difficulty in easily producing an immersion diffraction element. In addition, because the processible shape is restricted by the crystal orientation, there arises a problem of insufficient degrees of freedom in the design of the diffraction portion and therefore difficulty in increasing the optical degrees of freedom.

An object of the present invention is to provide: an immersion diffraction element easily producible and capable of increasing the degrees of freedom in the design of the diffraction portion; and a method for producing the immersion diffraction element.

### Solution to Problem

An immersion diffraction element according to a first invention of the present application includes a prism portion and a diffraction portion and the prism portion and the diffraction portion are made of amorphous glass.

An immersion diffraction element according to a second invention of the present application includes: a prism portion having a first principal surface, a second principal surface, and a third principal surface; and a diffraction portion provided on the first principal surface of the prism portion and made of amorphous glass.

Hereinafter, the first invention and the second invention of the present application may be referred to collectively as the present invention.

In the present invention, the amorphous glass preferably has a refractive index of 3.0 or more at a wavelength of 10 μm.

In the present invention, the amorphous glass is preferably chalcogenide glass.

In the present invention, the amorphous glass may contain, in terms of percent by mole, 4% to 80% Te, 0% to 50% Ge (exclusive of 0%), and 0% to 20% Ga.

In the present invention, the amorphous glass may contain, in terms of percent by mole, 50% to 80% S, 0% to 40% Sb (exclusive of 0%), 0% to 18% Ge (exclusive of 0%), 0% to 20% Sn, and 0% to 20% Bi.

In the present invention, the diffraction portion preferably has a value of 2.0 or less obtained by dividing a corner R of a trough of a recessed area by a corner R of a crest of a raised area. More preferably, an angle formed by faces defining the trough of the recessed area is not less than 60° and not more than 120°.

In the present invention, a surface of the diffraction portion is preferably covered with a reflective film. More preferably, the reflective film is made of Au.

In the second invention, an absolute value of a difference in refractive index at a wavelength of 10 μm between a material constituting the prism portion and the amorphous glass constituting the diffraction portion is preferably 0.3 or less.

In the second invention, an absolute value of a difference in coefficient of thermal expansion between a material constituting the prism portion and the amorphous glass constituting the diffraction portion is preferably 150×10⁻⁷/° C. or less.

In the second invention, the prism portion is preferably made of Si.

In the second invention, it is preferred that the diffraction portion has a diffraction optical surface, a bottom surface opposed to the diffraction optical surface, and a side surface connected to the diffraction optical surface and the bottom surface, and that the diffraction portion and the prism portion are bonded together, without soldering between the first principal surface of the prism portion and the bottom surface of the diffraction portion, by a solder provided across the side surface of the diffraction portion and the prism portion and the solder has a melting point lower than a glass transition point of the amorphous glass.

In the second invention, an absolute value of a difference in coefficient of thermal expansion between the solder and the amorphous glass is preferably 170×10⁻⁷/° C. or less.

In the second invention, the solder preferably contains In, Sn or Bi.

In the second invention, the solder is preferably provided around the entire side surface of the diffraction portion.

In the second invention, it is preferred that the immersion diffraction element further includes a first underlying film provided on the first principal surface of the prism portion and the solder is provided across the side surface of the diffraction portion and the first underlying film.

In the second invention, the first underlying film is preferably provided to surround the diffraction portion when viewed from a direction where the diffraction optical surface and the bottom surface are opposed to each other.

In the second invention, the first underlying film is preferably provided outside a region between the diffraction portion and the prism portion.

In the second invention, the diffraction portion is preferably provided on the first principal surface of the prism portion with a second underlying film in between.

In the second invention, the second underlying film is preferably made of Si.

A method for producing an immersion diffraction element according to a first invention of the present application includes the steps of: preparing amorphous glass; and mold press forming the amorphous glass to form a diffraction portion.

A method for producing an immersion diffraction element according to a second invention of the present application includes the steps of: preparing a prism and amorphous glass; mold press forming the amorphous glass to form a diffraction portion; and bonding the prism and the diffraction portion together.

In the present invention, in forming a recessed area and a raised area of the diffraction portion, the amorphous glass is preferably mold press formed so that a value obtained by dividing a corner R of a trough of the recessed area by a corner R of a crest of the raised area is 2.0 or less. More preferably, in forming the recessed area and the raised area of the diffraction portion, the amorphous glass is mold press formed so that an angle formed by faces defining the trough of the recessed area is not less than 60° and not more than 120°.

In the present invention, in forming a recessed area and a raised area of the diffraction portion, the amorphous glass is preferably mold press formed using a press mold which has a counter-shape to the recessed area and the raised area of the diffraction portion and whose value obtained by dividing a corner R of a crest of a raised area by a corner R of a trough of a recessed area is 10.0 or less. More preferably, the amorphous glass is mold press formed using a press mold having an angle of not less than 60° and not more than 120° formed by faces defining the trough of the recessed area.

In the present invention, the amorphous glass preferably has a glass transition point of not lower than 140° C. and not higher than 250° C.

In the present invention, in forming the diffraction portion, the amorphous glass is preferably mold press formed at a temperature of not lower than a glass transition temperature of the amorphous glass plus 5° C. and not higher than the glass transition temperature plus 50° C.

In the present invention, in forming the diffraction portion, the amorphous glass is preferably mold press formed using a press mold plated with nickel and phosphorus.

In the second invention, in the step of bonding the prism and the diffraction portion together, it is preferred that the diffraction portion is disposed on a first principal surface of the prism, a solder is provided across a side surface of the diffraction portion and the prism, and the prism and the diffraction portion are bonded with the solder.

### Advantageous Effects of Invention

The present invention enables provision of: an immersion diffraction element easily producible and capable of increasing the degrees of freedom in the design of the diffraction portion; and a method for producing the immersion diffraction element.

### BRIEF DESCRIPTION OF DRAWINGS

FIG. 1 is a schematic cross-sectional view showing an immersion diffraction element according to a first embodiment of the present invention.

FIG. 2 is a schematic plan view showing a diffraction surface of the immersion diffraction element according to the first embodiment of the present invention.

FIG. 3 is a schematic cross-sectional view for illustrating spectral separation in the immersion diffraction element.

FIG. 4 is an enlarged view of a diffraction portion in FIG. 3.

FIG. 5 is a schematic cross-sectional view for illustrating a press mold for use in a method for producing an immersion diffraction element according to the first embodiment of the present invention.

FIG. 6 is a schematic cross-sectional view showing an immersion diffraction element according to a second embodiment of the present invention.

FIG. 7 is a schematic cross-sectional view showing an immersion diffraction element according to a third embodiment of the present invention.

FIG. 8 is a scanning electron microscopic (SEM) photograph of a mold used in an experimental example.

FIG. 9 is a scanning electron microscopic (SEM) photograph of the mold used in the experimental example.

FIG. 10 is a scanning electron microscopic (SEM) photograph of an immersion diffraction element produced in the experimental example.

FIG. 11 is a scanning electron microscopic (SEM) photograph of the immersion diffraction element produced in the experimental example.

FIG. 12 is a scanning electron microscopic (SEM) photograph of the immersion diffraction element produced in the experimental example.

FIG. 13 is a schematic cross-sectional view showing an immersion diffraction element according to a fourth embodiment of the present invention.

FIG. 14 is a schematic plan view showing a diffraction surface of the immersion diffraction element according to the fourth embodiment of the present invention.

FIG. 15 is a schematic cross-sectional view for illustrating spectral separation in the immersion diffraction element.

FIG. 16 is an enlarged view of a diffraction portion in FIG. 15.

FIG. 17 is a schematic cross-sectional view for illustrating a press mold for use in a method for producing an immersion diffraction element according to the fourth embodiment of the present invention.

FIG. 18 is a schematic cross-sectional view showing an immersion diffraction element according to a fifth embodiment of the present invention.

FIG. 19 is a schematic plan view showing a diffraction surface of the immersion diffraction element according to the fifth embodiment of the present invention.

FIG. 20 is a schematic cross-sectional view showing a modification of the immersion diffraction element according to the fifth embodiment of the present invention.

FIG. 21 is a schematic cross-sectional view showing an immersion diffraction element according to a sixth embodiment of the present invention.

FIG. 22 is a schematic cross-sectional view showing an immersion diffraction element according to a seventh embodiment of the present invention.

FIG. 23 is a schematic cross-sectional view showing an immersion diffraction element according to an eighth embodiment of the present invention.

### DESCRIPTION OF EMBODIMENTS

Hereinafter, a description will be given of preferred embodiments. However, the following embodiments are merely illustrative and the present invention is not limited to the following embodiments. Throughout the drawings, members having substantially the same functions may be referred to by the same reference characters. First to third embodiments describe the first invention and fourth to eighth embodiments describe the second invention.

### First Embodiment

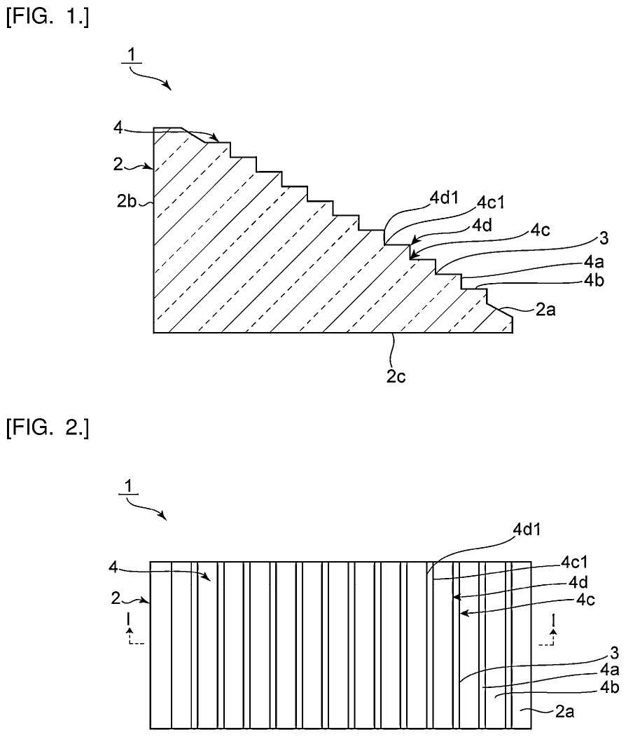

FIG. 1 is a schematic cross-sectional view showing an immersion diffraction element according to a first embodiment of the present invention. FIG. 2 is a schematic plan view showing a diffraction surface of the immersion diffraction element according to the first embodiment of the present invention. FIG. 1 is a schematic cross-sectional view taken along the line I-I in FIG. 2.

As shown in FIG. 1, an immersion diffraction element 1 includes a prism portion 2 and a diffraction portion 4. The prism portion 2 and the diffraction portion 4 are provided as an integral unit.

The prism portion 2 has the shape of a triangular prism. The prism portion 2 has a first face 2a, a second face 2b, and a third face 2c. The first face 2a, the second face 2b, and the third face 2c correspond to the lateral faces of the shape of a triangular prism.

As shown in FIGS. 1 and 2, in the first face 2a of the prism portion 2, a plurality of diffraction grooves 3 are periodically provided. Thus, the diffraction portion 4 is formed. More specifically, the plurality of diffraction grooves 3 are provided so that the diffraction portion 4 has a stepped shape. However, the shape of the prism portion 2 is not particularly limited so long as it has a face in which a diffraction portion 4 can be provided.

The diffraction portion 4 has fourth faces 4a and fifth faces 4b. The fourth faces 4a and the fifth faces 4b are alternately and repeatedly provided, which alternately and repeatedly provides recessed areas 4c and raised areas 4d. In this manner, the stepped diffraction portion 4 is formed.

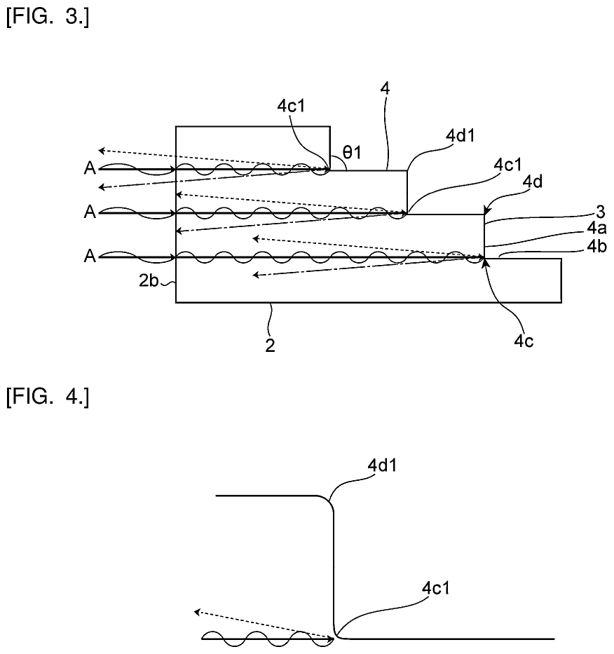

FIG. 3 is a schematic cross-sectional view for illustrating spectral separation in the immersion diffraction element. FIG. 4 is an enlarged view of a diffraction portion in FIG. 3. Hatching is omitted from FIGS. 3 and 4.

As shown in FIG. 3, the second face 2b of the prism portion 2 is a light entrance portion of the immersion diffraction element 1. The diffraction portion 4 includes a trough 4c1 shown in FIG. 4. More specifically, the diffraction portion 4 includes a plurality of troughs 4c1. As shown in FIG. 3, light A is incident from the second face 2b, passes through the prism portion 2, and reaches the diffraction portion 4. Then, light A is reflected and diffracted at each of the fourth faces 4a and each of the troughs 4c1 and thus spectrally separated. The broken arrows and dash-single-dot arrows in FIG. 3 represent examples of spectrally separated light beams. The spectrally separated light beams exit from the prism portion 2. As shown by the wavy lines in FIG. 3, the wavelength of light A inside the prism portion 2 is shorter than the wavelength of light A outside the prism portion 2. Therefore, the pitch of the diffraction grooves 3 necessary for spectral separation can be shortened. Accordingly, the immersion diffraction element 1 can achieve both of improvement in wavelength resolution and size reduction.

In the immersion diffraction element 1 according to this embodiment, the prism portion 2 and the diffraction portion 4 are made of amorphous glass. Therefore, the immersion diffraction element 1 can be easily produced and can increase the degrees of freedom in the design of the diffraction portion 4.

Heretofore, the diffraction portion of an immersion diffraction element is made of a crystal material, such as single-crystal Ge. In the case where the diffraction portion is made of a crystal material as just described, its diffraction grooves are formed by subjecting the crystal material to cutting, etching or like processing. Therefore, there is a problem of difficulty in easily producing an immersion diffraction element. In addition, in the case where the diffraction portion is made of a crystal material, the processible shape is restricted by the crystal orientation, which presents a problem of insufficient degrees of freedom in the design of the diffraction portion and therefore difficulty in increasing the optical degrees of freedom.

Unlike the above, in the immersion diffraction element 1 according to this embodiment, the prism portion 2 and the diffraction portion 4 are made of amorphous glass. Therefore, as will be described in the later chapter of a production method, the immersion diffraction element 1 can be easily formed by subjecting the prism portion 2 to mold press forming. In addition, amorphous glass is free from restrictions on processible shape due to crystal orientation and, therefore, can increase the degrees of freedom in the design of the diffraction portion 4. Accordingly, the immersion diffraction element 1 according to this embodiment can increase the optical degrees of freedom.

The term “amorphous glass” used herein refers to a material found to have no crystalline peak but have a halo pattern specific for glass when measured by X-ray powder diffraction.

In this embodiment, the refractive index of the amorphous glass constituting the prism portion 2 and the diffraction portion 4 at a wavelength of 10 μm is preferably 3.0 or more, more preferably 3.1 or more, and still more preferably 3.2 or more. When the refractive index of the amorphous glass is not less than the above lower limit, the immersion diffraction element 1 can be further reduced in size. The upper limit of the refractive index of the amorphous glass is not particularly limited, but may be, for example, not more than 4.1 judging from the nature of the material.

The amorphous glass constituting the prism portion 2 and the diffraction portion 4 is preferably chalcogenide glass. In this case, the refractive index of the amorphous glass can be further increased.

Particularly, the amorphous glass is preferably a glass containing, in terms of percent by mole, 4% to 80% Te, 0% to 50% Ge (exclusive of 0%), and 0% to 20% Ga. In this case, the refractive index of the amorphous glass can be further increased.

In the above amorphous glass, the content of Te is, in terms of percent by mole, more preferably not less than 10%, still more preferably not less than 20%, particularly preferably not less than 30%, more preferably not more than 75%, and still more preferably not more than 70%. If the content of Te in the amorphous glass is less than 4%, vitrification is less likely to occur. On the other hand, if the content of Te in the amorphous glass is more than 80%, Te-based crystals are precipitated from the glass, which may make it difficult to achieve a refractive index and a transmittance meeting the properties of the immersion diffraction element 1, and the amount of Te evaporated in mold press forming increases, which may deteriorate the plane quality of the immersion diffraction element 1.

In the above amorphous glass, the content of Ge is, in terms of percent by mole, more preferably not less than 1%, still more preferably not less than 5%, more preferably not more than 40%, and still more preferably not more than 30%. If the amorphous glass is free of Ge, vitrification is less likely to occur. On the other hand, if the content of Ge in the amorphous glass is more than 50%, Ge-based crystals are precipitated from the glass, which may make it difficult to achieve a refractive index and a transmittance meeting the properties of the immersion diffraction element 1, and the viscosity of glass in mold press forming increases, which may deteriorate the shape followability of the diffraction portion 4 to a press mold 10 to be described later.

In the above amorphous glass, the content of Ga is, in terms of percent by mole, more preferably not less than 0.1%, still more preferably not less than 1%, more preferably not more than 15%, and still more preferably not more than 10%. When the amorphous glass contains Ga, the vitrification range can be further extended to further increase the thermal stability of the glass (the stability of vitrification).

Alternatively, the amorphous glass preferably contains, in terms of percent by mole, 50% to 80% S, 0% to 40% Sb (exclusive of 0%), 0% to 18% Ge (exclusive of 0%), 0% to 20% Sn, and 0% to 20% Bi. In this case, the refractive index of the amorphous glass can be further increased.

In the above amorphous glass, the content of S is, in terms of percent by mole, more preferably not less than 55%, still more preferably not less than 60%, more preferably not more than 75%, and still more preferably not more than 70%. If the content of S in the amorphous glass is less than 50%, vitrification is less likely to occur. On the other hand, if the content of S in the amorphous glass is more than 80%, the weather resistance of the glass decreases, which may restrict the use conditions of the immersion diffraction element 1.

In the above amorphous glass, the content of Sb is, in terms of percent by mole, more preferably not less than 5%, still more preferably not less than 10%, more preferably not more than 35%, and still more preferably not more than 33%. If the amorphous glass is free of Sb or the content of Sb therein is more than 40%, vitrification may be less likely to occur.

In the above amorphous glass, the content of Ge is, in terms of percent by mole, more preferably not less than 2%, still more preferably not less than 4%, and more preferably not more than 15%. If the glass is free of Ge, vitrification is less likely to occur. On the other hand, if the content of Ge in the amorphous glass is more than 18%, Ge-based crystals are precipitated from the glass, which may make it difficult to achieve a refractive index and a transmittance meeting the properties of the immersion diffraction element 1, and the viscosity of glass in mold press forming increases, which may deteriorate the shape followability of the diffraction portion 4 to a press mold 10 to be described later.

In the above amorphous glass, the content of Sn is, in terms of percent by mole, more preferably not less than 1%, still more preferably not less than 5%, more preferably not more than 15%, and still more preferably not more than 10%. The component Sn in the amorphous glass is a component accelerating vitrification. However, if the content of Sn in the amorphous glass is more than 20%, vitrification is less likely to occur.

In the above amorphous glass, the content of Bi is, in terms of percent by mole, more preferably not less than 0.5%, still more preferably not less than 2%, more preferably not more than 10%, and still more preferably not more than 8%. The component Bi in the amorphous glass is a component that reduces the energy necessary to vitrify a source material during glass melting. However, if the content of Bi in the amorphous glass is more than 20%, Bi-based crystals are precipitated from the glass, which may make it difficult to achieve a refractive index and a transmittance meeting the properties of the immersion diffraction element 1.

The density of the amorphous glass constituting the prism portion 2 and the diffraction portion 4 is preferably 6.5 g/cm³ or less, more preferably 6.3 g/cm³ or less, and still more preferably 6.0 g/cm³ or less. When the density of the amorphous glass satisfies the above range, the immersion diffraction element 1 can be further reduced in weight.

Furthermore, as for the amorphous glass constituting the prism portion 2 and the diffraction portion 4, its internal transmittance in an infrared wavelength range of 7.0 μm to 11.0 μm is preferably 80% or more, more preferably 85% or more, and still more preferably 90% or more. In this case, a desired optical performance can be more certainly achieved. The upper limit of the internal transmittance in an infrared wavelength range of 7.0 μm to 11.0 μm may be, for example, 99.5%. The internal transmittance used herein refers to that when the thickness is 2.0 mm.

In this embodiment, the troughs 4c1 of the recessed areas 4c of the diffraction portion 4 preferably have a more acute shape than the crests 4d1 of the raised areas 4d. Significant effects on the properties of the immersion diffraction element 1 are given by the fourth faces 4a and the troughs 4c1 of the recessed areas 4c. Therefore, when the troughs 4c1 of the recessed areas 4c have a more acute shape than the crests 4d1 of the raised areas 4d, i.e., when the value obtained by dividing R4c1 by R4d1 is preferably 2.0 or less and more preferably 1.0 or less where R4c1 represents the corner R (radius, μm) of the troughs 4c1 of the recessed areas 4c and R4d1 represents the corner R (radius, μm) of the crests 4d1 of the raised areas 4d, the diffraction efficiency of the immersion diffraction element 1 can be further increased. The value of R4c1 is preferably 0.1 μm to 10 μm and the value of R4d1 is preferably 5 μm to 20 μm.

Furthermore, as shown in FIG. 3, the angle θ1 formed by the fourth face 4a and the fifth face 4b defining the trough 4c1 of each of the recessed areas 4c is preferably not less than 60°, more preferably not less than 65°, still more preferably not less than 70°, particularly preferably not less than 80°, preferably not more than 120°, more preferably not more than 115°, still more preferably not more than 110°, and particularly preferably not more than 100°. The angle θ1 formed by the fourth face 4a and the fifth face 4b defining the trough 4c1 of each of the recessed areas 4c is preferably 90°±1° and particularly preferably 90°. In this case, the diffraction efficiency of the immersion diffraction element 1 can be further increased.

Hereinafter, a description will be given of an example of a production method of an immersion diffraction element 1.

### (Production Method)

In a production method according to this embodiment, amorphous glass is first prepared. As the amorphous glass, the same material as the amorphous glass constituting the above-described prism portion 2 and diffraction portion 4 can be used. The glass prepared as the amorphous glass is, for example, a base material glass made of a chalcogenide glass that has a glass composition of, in terms of percent by mole, 60% of S, 30% of Sb, 5% of Ge, and 5% of Sn or a chalcogenide glass that has a glass composition of, in terms of percent by mole, 70% of Te, 25% of Ge, and 5% of Ga. Next, the amorphous glass is mold press formed to form a diffraction portion 4. Specifically, a prism portion 2 and a diffraction portion 4 can be formed by preparing a prism (precursor prism) made of the amorphous glass and mold press forming the precursor prism.

In the production method according to this embodiment, the diffraction portion 4 can be easily formed by mold press forming the precursor prism. In addition, because amorphous glass can be subjected to imprinting processing in the above manner and is free from restrictions on processible shape due to crystal orientation, the degrees of freedom in the design of the diffraction portion 4 can be increased. Accordingly, the production method according to this embodiment can increase the optical degrees of freedom of the immersion diffraction element 1.

In the present invention, in forming recessed and raised areas of the diffraction portion 4, the amorphous glass is preferably mold press formed so that the value obtained by dividing R4c1 by R4d1 is preferably 2.0 or less and more preferably 1.0 or less where R4c1 represents the corner R of the troughs 4c1 of the recessed areas 4c and R4d1 represents the corner R of the crests 4d1 of the raised areas 4d. As shown in FIG. 3, in the resultant diffraction portion 4, the fourth faces 4a and the troughs 4c1 of the recessed areas 4c have significant effects on the properties of the immersion diffraction element 1. Therefore, when the value obtained by dividing R4c1 by R4d1 is defined as described above, the diffraction efficiency of the immersion diffraction element 1 can be further increased. The value of R4c1 is preferably 0.1 μm to 10 μm and the value of R4d1 is preferably 5 μm to 20 μm.

Furthermore, in the present invention, in forming recessed and raised areas of the diffraction portion 4, the amorphous glass is preferably mold press formed so that the angle formed by the fourth face 4a and the fifth face 4b defining the trough 4c1 of each of the recessed areas 4c is not less than 60° and not more than 120°. The angle formed by the fourth face 4a and the fifth face 4b defining the trough 4c1 of each of the recessed areas 4c is more preferably not less than 65°, still more preferably not less than 70°, particularly preferably not less than 80°, more preferably not more than 115°, still more preferably not more than 110°, and particularly preferably not more than 100°. The angle formed by the fourth face 4a and the fifth face 4b defining the trough 4c1 of each of the recessed areas 4c is preferably 90°±1° and more preferably 90°. In this case, the diffraction efficiency of the immersion diffraction element 1 can be further increased.

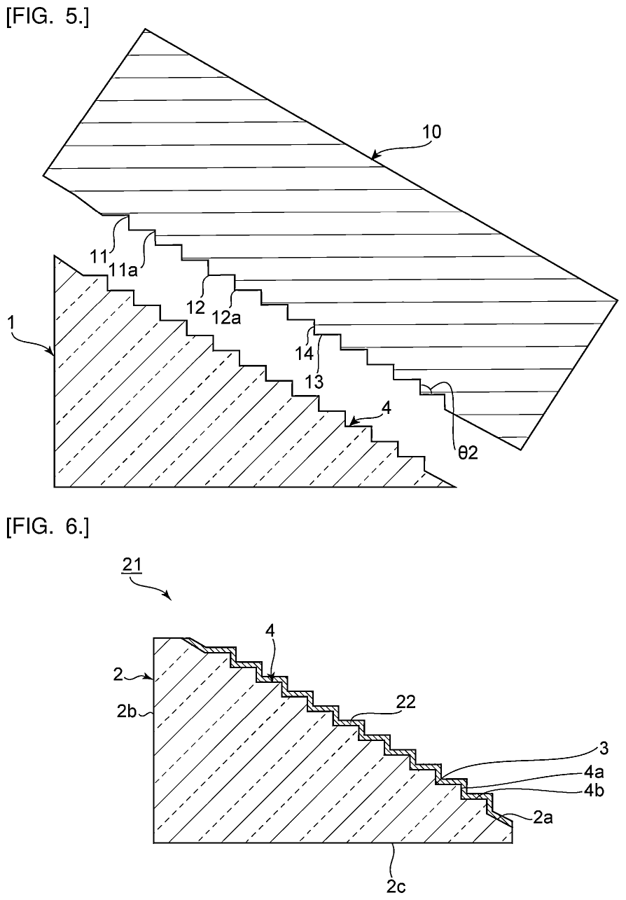

FIG. 5 is a schematic cross-sectional view for illustrating a press mold for use in a method for producing an immersion diffraction element according to the first embodiment of the present invention.

As shown in FIG. 5, a press mold 10 has a counter-shape to the recessed and raised areas of the diffraction portion 4. In the press mold 10, the crests 12a of its raised areas 12 preferably have a more acute shape than the troughs 11a of its recessed areas 11 and, specifically, the value obtained by dividing R12a by R11a is preferably 10.0 or less and more preferably 8.0 or less where R12a represents the corner R of the crests 12a of the raised areas 12 and R11a represents the corner R of the troughs 11a of the recessed areas 11. When the amorphous glass is mold press formed using this press mold 10, the value obtained by dividing R4c1 by R4d1 in relation to the diffraction portion 4 can be more certainly led to 10.0 or less, preferably 2.0 or less, and more preferably 1.0 or less and, thus, the diffraction efficiency of the immersion diffraction element 1 can be further increased. The value of R11a is preferably 1 μm to 20 μm and the value of R12a is preferably 0.05 μm to 10 μm.

Furthermore, in the press mold 10, the angle θ2 formed by a sixth face 13 and a seventh face 14 defining the crest 12a of each of the raised areas 12 is preferably not less than 60°, more preferably not less than 65°, still more preferably not less than 70°, particularly preferably not less than 80°, preferably not more than 120°, more preferably not more than 115°, still more preferably not more than 110°, and particularly preferably not more than 100°. The angle θ2 formed by the sixth face 13 and the seventh face 14 defining the crest 12a of each of the raised areas 12 is preferably 90°±1° and more preferably 90°. When the amorphous glass is mold press formed using this press mold 10, the angle formed by the fourth face 4a and the fifth face 4b defining the trough 4c1 of each of the recessed areas 4c can be adjusted within the above-described preferred range and, thus, the diffraction efficiency of the immersion diffraction element 1 can be further increased.

The material for the press mold 10 is not particularly limited, but, for example, an ultrahard material, STAVAX, HPM38 or so on can be used. A press mold plated with nickel and phosphorus may be used as the press mold 10.

In the present invention, in forming the diffraction portion 4, the amorphous glass is preferably mold press formed at a temperature of not lower than the glass transition temperature of the amorphous glass plus 5° C. and not higher than the glass transition temperature plus 50° C. The mold press forming temperature of the amorphous glass is more preferably not lower than the glass transition temperature of the amorphous glass plus 10° C. and not higher than the glass transition temperature plus 45° C., and still more preferably not lower than the glass transition temperature of the amorphous glass plus 15° C. and not higher than the glass transition temperature plus 40° C.

The glass transition point of the above amorphous glass is preferably not lower than 140° C., more preferably not lower than 145° C., still more preferably not lower than 150° C., preferably not higher than 250° C., more preferably not higher than 245° C., and still more preferably not higher than 240° C.

When mold press formed at such a temperature as described above, the amorphous glass can be pressed at a lower temperature and, therefore, heat variation is further less likely to occur even when a large-sized amorphous glass is molded. In addition, heat distortion that may cause a dimension change can be further less likely to occur.

Although a press mold plated with nickel and phosphorus may be difficult to use at high temperatures because of crystallization, it can be suitably used upon pressing at such a low temperatures as described above. With the use of a press mold plated with nickel and phosphorus, the surface specularity for the press mold can be more easily obtained and the surface precision of mold press forming can be thus further increased, which further increases the degrees of freedom in the design of the diffraction portion 4. Although herein a press mold plated with nickel and phosphorus is described as an example, the type of plating is not limited to this and examples that can be used include plating with nickel and molybdenum and plating with nickel and tungsten.

### Experimental Example

In an experimental example, an immersion diffraction element was produced based on the method for producing an immersion diffraction element according to the first embodiment of the present invention. Specifically, amorphous glass was mold press formed under conditions of a temperature of 185° C., a pressing time of one minute, and a pressing pressure of 2 kN in a reduced-pressure environment (the degree of vacuum: 0.3 Pa), thus producing an immersion diffraction element. The amorphous glass used was a chalcogenide glass containing, as a glass composition in terms of percent by mole, 70% Te, 20% Ge, and 10% Ga.

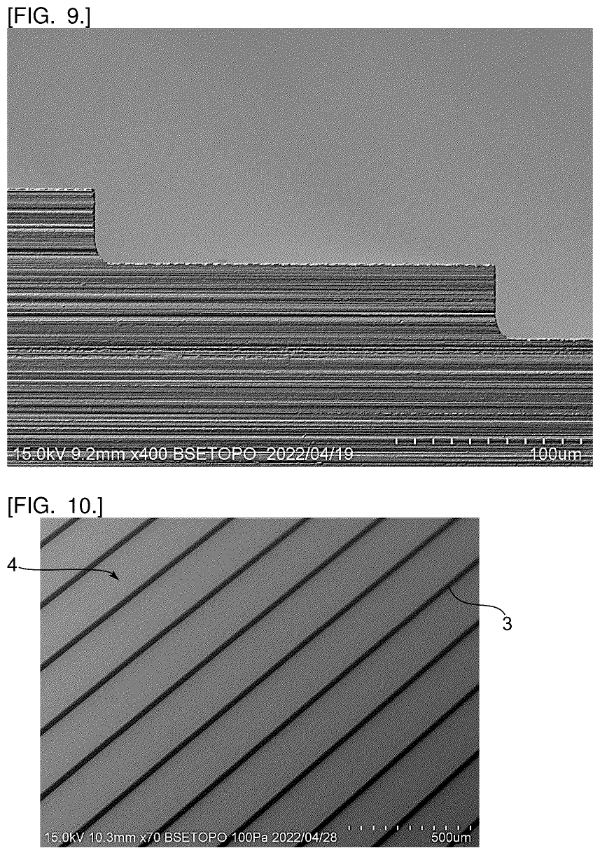

FIGS. 8 and 9 are scanning electron microscopic (SEM) photographs of the mold used in the experimental example. FIG. 8 is a SEM photograph of a cross section of a diffraction surface forming portion of the mold used in the experimental example, and FIG. 9 is an enlarged view of the diffraction surface forming portion. An ultrahard material (Ultrahard EF10 manufactured by Kyoritsu Gokin Co., Ltd.) was used as a material for the mold.

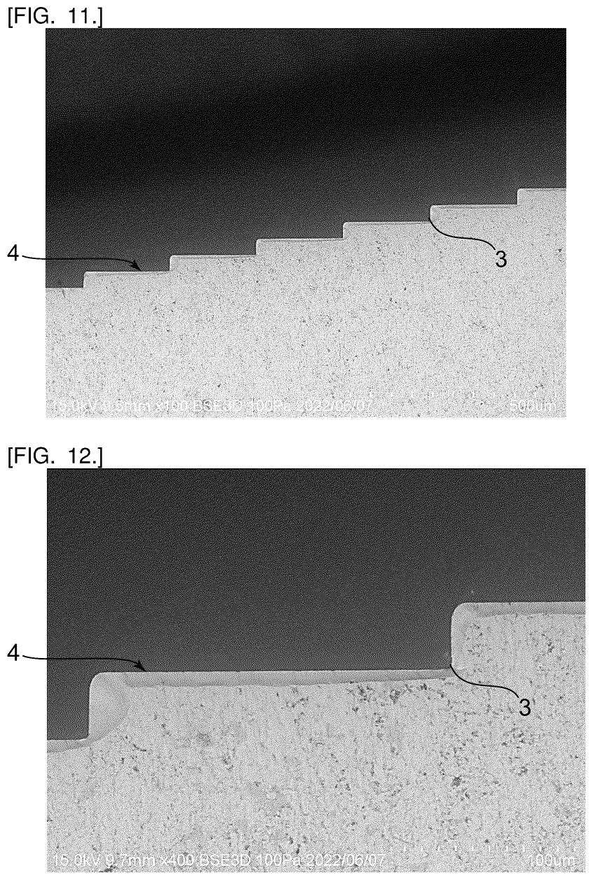

FIGS. 10 to 12 are scanning electron microscopic (SEM) photographs of the immersion diffraction element produced in the experimental example. FIG. 10 is a SEM photograph of a diffraction surface of the immersion diffraction element. FIG. 11 is a SEM photograph of a cross section of the immersion diffraction element and FIG. 12 is an enlarged view of a diffraction portion thereof.

As shown in FIGS. 10 to 12, in the immersion diffraction element produced by mold press forming, the diffraction portion 4 and the diffraction grooves 3 are less likely to chip. This can be explained as follows.

A conventional immersion diffraction element obtained by subjecting a crystal material or an amorphous glass material directly to cutting, polishing or like processing has a problem of ease of chipping of the diffraction portion. Unlike this, when an ultrahard material or like steel is subjected to cutting, polishing or like processing, a diffraction portion is less likely to chip. Therefore, when amorphous glass is subjected to mold imprinting using such a mold as shown in FIGS. 8 and 9, the amorphous glass can be given a diffraction structure kept from chipping.

Since, as just described, the immersion diffraction element of this experimental example produced by mold press forming is less likely to produce chipping at the diffraction portion 4 and the diffraction grooves 3 as compared to the case of subjecting a crystal material to cutting, polishing or like processing, light scattering due to the chipping can be reduced and the optical properties (diffraction properties) can be less likely to be deteriorated.

Furthermore, as shown in FIGS. 10 to 12, in the immersion diffraction element obtained by mold press forming, processing dust due to chipping does not adhere to the diffraction portion 4 and the diffraction grooves 3. Therefore, after the deposition of a reflective film or the like to be described hereinafter, separation of the reflective film, which may be caused by the processing dust, can be prevented. Thus, reflection loss or light scattering can be reduced.

In addition, when, as in this experimental example, an immersion diffraction element is produced by mold press forming, processing dust due to chipping is less likely to be produced, which can eliminate the need to clean the immersion diffraction element to simplify the process and can make it less likely that the optical properties of the immersion diffraction element deteriorate. More specifically, if the immersion diffraction element is cleaned after cutting, polishing or like processing, the diffraction portion may be broken during cleaning or processing dust or floating dust may be collected in the diffraction portion and the diffraction grooves during cleaning, which may deteriorate the optical properties. This problem can be solved by producing the immersion diffraction element by mold press forming as in this experimental example.

### Second Embodiment

FIG. 6 is a schematic cross-sectional view showing an immersion diffraction element according to a second embodiment of the present invention.

As shown in FIG. 6, in an immersion diffraction element 21, the surface of a diffraction portion 4 is covered with a reflective film 22. More specifically, the reflective film 22 covers fourth faces 4a and fifth faces 4b of the diffraction portion 4.

The material for the reflective film 22 is not particularly limited, but metals, such as Au, can be used. An appropriate dielectric multi-layer may be used as the reflective film 22. The thickness of the reflective film 22 may be, for example, not less than 1 μm and not more than 10 μm. The reflective film 22 can be formed, for example, by a vapor deposition method or a sputtering method. Si may be used as an underlying film for the reflective film 22. The rest is the same as in the first embodiment.

Also in the immersion diffraction element 21 according to the second embodiment, the prism portion 2 and the diffraction portion 4 are made of amorphous glass. Therefore, the immersion diffraction element 21 can be easily produced and can increase the degrees of freedom in the design of the diffraction portion 4.

Furthermore, as in the immersion diffraction element 21, the surface of the diffraction portion 4 may be covered with a reflective film 22. In this case, light having entered the prism portion 2 can be more certainly reflected at the diffraction portion 4 and can be more certainly spectrally separated.

### Third Embodiment

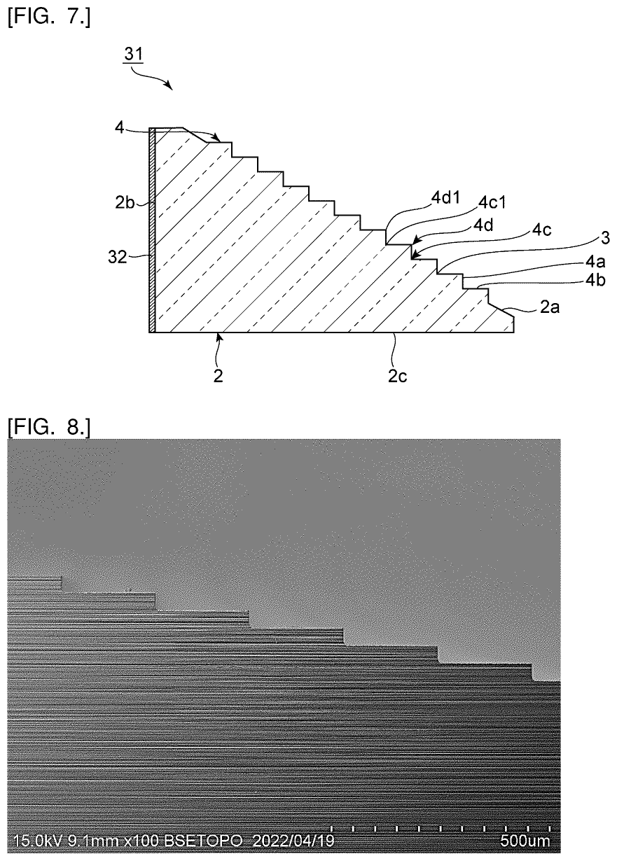

FIG. 7 is a schematic cross-sectional view showing an immersion diffraction element according to a third embodiment of the present invention.

As shown in FIG. 7, in an immersion diffraction element 31, an antireflection film 32 is provided on a second principal surface 2b of a prism portion 2.

The antireflection film 32 is preferably made of, for example, at least one selected from among Ge, Si, fluorides, ZnSe, ZnS, and diamond-like carbon.

The antireflection film 32 can be formed, for example, by a vapor deposition method or a sputtering method. The thickness of the antireflection film 32 may be, for example, not less than 1.0 μm and not more than 5.0 μm. The rest is the same as in the first embodiment.

Also in the immersion diffraction element 31 according to the third embodiment, the prism portion 2 and the diffraction portion 4 are made of amorphous glass. Therefore, the immersion diffraction element 31 can be easily produced and can increase the degrees of freedom in the design of the diffraction portion 4.

Furthermore, as in the immersion diffraction element 31, an antireflection film 32 may be provided on the second principal surface 2b of the prism portion 2. The second face 2b of the prism portion 2 is a light entrance portion of the immersion diffraction element 31. Therefore, when the antireflection film 32 is provided on the light entrance portion, incident light can be less likely to be reflected there. Thus, in this case, the light use efficiency of the immersion diffraction element 31 can be further increased.

### Fourth Embodiment

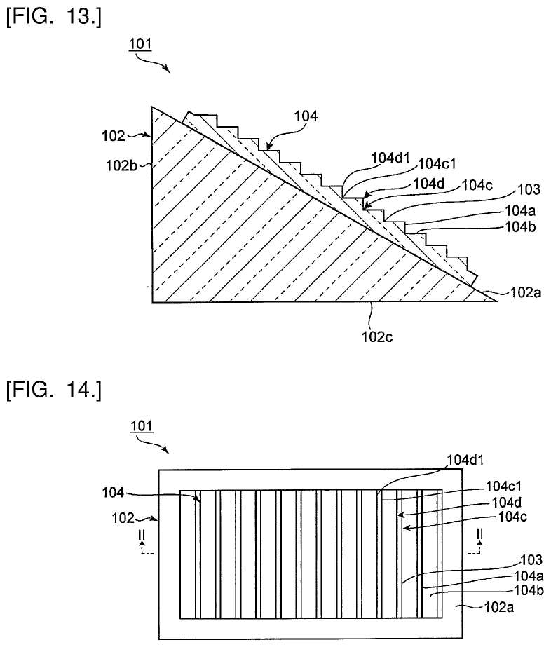

FIG. 13 is a schematic cross-sectional view showing an immersion diffraction element according to a fourth embodiment of the present invention. Furthermore, FIG. 14 is a schematic plan view showing a diffraction surface of the immersion diffraction element according to the fourth embodiment of the present invention. FIG. 13 is a schematic cross-sectional view taken along the line II-II in FIG. 14.

As shown in FIG. 13, an immersion diffraction element 101 includes a prism portion 102 and a diffraction portion 104. The prism portion 102 and the diffraction portion 104 are provided as separate units.

The prism portion 102 has the shape of a triangular prism. The prism portion 102 has a first face 102a (first principal surface 102a), a second face 102b (second principal surface 102b), and a third face 102c (third principal surface 102c). The first principal surface 102a, the second principal surface 102b, and the third principal surface 102c correspond to the lateral faces of the shape of a triangular prism. The diffraction portion 104 is provided on the first principal surface 102a of the prism portion 102. However, the shape of the prism portion 102 is not particularly limited so long as it has a face on which a diffraction portion 104 can be provided.

As shown in FIG. 14, in the diffraction portion 104, a plurality of diffraction grooves 103 are periodically provided. More specifically, the plurality of diffraction grooves 103 are provided so that the diffraction portion 104 has a stepped shape.

The diffraction portion 104 has fourth faces 104a and fifth faces 104b. The fourth faces 104a and the fifth faces 104b are alternately and repeatedly provided, which alternately and repeatedly provides recessed areas 104c and raised areas 104d. In this manner, the stepped diffraction portion 104 is formed.

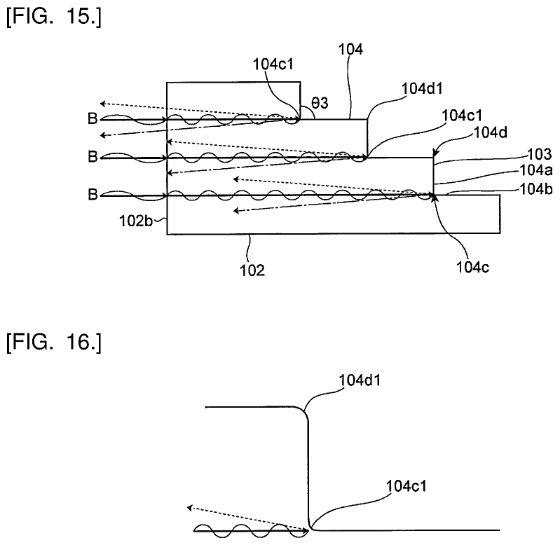

FIG. 15 is a schematic cross-sectional view for illustrating spectral separation in the immersion diffraction element. FIG. 16 is an enlarged view of a diffraction portion in FIG. 15. Hatching is omitted from FIGS. 15 and 16. Furthermore, these figures also omit the boundary between the prism portion 102 and the diffraction portion 104.

The second principal surface 102b of the prism portion 102 is a light entrance portion of the immersion diffraction element 101. The diffraction portion 104 includes a trough 104c1 shown in FIG. 16. More specifically, the diffraction portion 104 includes a plurality of troughs 104c1. As shown in FIG. 15, light B is incident from the second principal surface 102b, passes through the prism portion 102, and reaches the diffraction portion 104. Then, light B is reflected and diffracted at each of the fourth faces 104a and each of the troughs 104c1 and thus spectrally separated. The broken arrows and dash-single-dot arrows in FIG. 15 represent examples of spectrally separated light beams. The spectrally separated light beams exit from the prism portion 102. As shown by the wavy lines in FIG. 15, the wavelength of light B inside the prism portion 102 is shorter than the wavelength of light B outside the prism portion 102. Therefore, the pitch of the diffraction grooves 103 necessary for spectral separation can be shortened. Accordingly, the immersion diffraction element 101 can achieve both of improvement in wavelength resolution and size reduction.

In the immersion diffraction element 101 according to this embodiment, the diffraction portion 104 is made of amorphous glass. The term “amorphous glass” used herein refers to a material found to have no crystalline peak but have a halo pattern specific for glass when measured by X-ray powder diffraction.

Since the immersion diffraction element 101 according to this embodiment has the above structure, it can be easily produced and can increase the degrees of freedom in the design of the diffraction portion 104.

Heretofore, the diffraction portion of an immersion diffraction element is made of a crystal material, such as single-crystal Ge. In the case where the diffraction portion is made of a crystal material as just described, its diffraction grooves are formed by subjecting the crystal material to cutting, etching or like processing. Therefore, there is a problem of difficulty in easily producing an immersion diffraction element. In addition, in the case where the diffraction portion is made of a crystal material, the processible shape is restricted by the crystal orientation, which presents a problem of insufficient degrees of freedom in the design of the diffraction portion and therefore difficulty in increasing the optical degrees of freedom.

Unlike the above, in the immersion diffraction element 101 according to this embodiment, the diffraction portion 104 is made of amorphous glass. Therefore, as will be described in the later chapter of a production method, the diffraction portion 104 can be easily formed by mold press forming the amorphous glass. In addition, amorphous glass is free from restrictions on processible shape due to crystal orientation and, therefore, can increase the degrees of freedom in the design of the diffraction portion 104. Accordingly, the immersion diffraction element 101 according to this embodiment can increase the optical degrees of freedom.

In this embodiment, the material constituting the prism portion 102 is not particularly limited, but, for example, Si, GaAs or so on can be used. The material for the prism portion 102 may be the same type of amorphous glass as that for the diffraction portion 104. These materials may be used singly or in a combination of a plurality of them.

The refractive index of the material constituting the prism portion 102 at a wavelength of 10 μm is preferably 3.0 or more, more preferably 3.1 or more, and still more preferably 3.2 or more. When the refractive index of the material constituting the prism portion 102 is not less than the above lower limit, the immersion diffraction element 101 can be further reduced in size. The upper limit of the refractive index of the material constituting the prism portion 102 is not particularly limited, but may be, for example, not more than 4.1 judging from the nature of the material.

The density of the material constituting the prism portion 102 is preferably 6.5 g/cm³ or less and more preferably 6.3 g/cm³ or less. When the density of the material constituting the prism portion 102 is within the above range, the immersion diffraction element 101 can be further reduced in weight.

As for the material constituting the prism portion 102, its internal transmittance in an infrared wavelength range of 7.0 μm to 11.0 μm is preferably 80.0% or more, more preferably 85.0% or more, and still more preferably 90.0% or more. In this case, a desired optical performance can be more certainly achieved. The upper limit of the internal transmittance in an infrared wavelength range of 7.0 μm to 11.0 μm may be, for example, not more than 99.5%. The internal transmittance used herein refers to that when the thickness is 2.0 mm.

The absolute value of a difference in refractive index at a wavelength of 10 μm between the material constituting the prism portion 102 and the amorphous glass constituting the diffraction portion 104 is preferably 0.3 or less, more preferably 0.28 or less, and still more preferably 0.26 or less. In this case, the light use efficiency can be further increased. The lower limit of the absolute value of a difference in refractive index at a wavelength of 10 μm between the material constituting the prism portion 102 and the amorphous glass constituting the diffraction portion 104 is not particularly limited, but may be, for example, not less than 0.01. However, any combination of materials having the same refractive index is not excluded.

The absolute value of a difference in coefficient of thermal expansion between the material constituting the prism portion 102 and the amorphous glass constituting the diffraction portion 104 is preferably 150×10⁻⁷/° C. or less, more preferably 140×10−7/° C. or less, and still more preferably 130×10⁻⁷/° C. or less. In this case, the adhesion between the prism portion 102 and the diffraction portion 104 can be further increased.

In this embodiment, the amorphous glass constituting the diffraction portion 104 is preferably chalcogenide glass. In this case, the refractive index of the amorphous glass can be further increased.

Particularly, the amorphous glass is preferably a glass containing, in terms of percent by mole, 4% to 80% Te, 0% to 50% Ge (exclusive of 0%), and 0% to 20% Ga. In this case, the refractive index of the amorphous glass can be further increased.

In the above amorphous glass, the content of Te is, in terms of percent by mole, more preferably not less than 10%, still more preferably not less than 20%, particularly preferably not less than 30%, more preferably not more than 75%, and still more preferably not more than 70%. If the content of Te in the amorphous glass is less than 4%, vitrification is less likely to occur. On the other hand, if the content of Te in the amorphous glass is more than 80%, Te-based crystals are precipitated from the glass, which may make it difficult to achieve a refractive index and an internal transmittance meeting the properties of the immersion diffraction element 101, and the amount of Te evaporated in mold press forming increases, which may deteriorate the plane quality of the immersion diffraction element 101.

In the above amorphous glass, the content of Ge is, in terms of percent by mole, more preferably not less than 1%, still more preferably not less than 5%, more preferably not more than 40%, and still more preferably not more than 30%. If the amorphous glass is free of Ge, vitrification is less likely to occur. On the other hand, if the content of Ge in the amorphous glass is more than 50%, Ge-based crystals are precipitated from the glass, which may make it difficult to achieve a refractive index and an internal transmittance meeting the properties of the immersion diffraction element 101, and the viscosity of glass in mold press forming increases, which may deteriorate the shape followability of the diffraction portion 104 to a press mold 110 to be described later.

In the above amorphous glass, the content of Ga is, in terms of percent by mole, more preferably not less than 0.1%, still more preferably not less than 1%, more preferably not more than 15%, and still more preferably not more than 10%. When the amorphous glass contains Ga, the vitrification range can be further extended to further increase the thermal stability of the glass (the stability of vitrification).

Alternatively, the amorphous glass preferably contains, in terms of percent by mole, 50% to 80% S, 0% to 40% Sb (exclusive of 0%), 0% to 18% Ge (exclusive of 0%), 0% to 20% Sn, and 0% to 20% Bi. In this case, the refractive index of the amorphous glass can be further increased.

In the above amorphous glass, the content of S is, in terms of percent by mole, more preferably not less than 55%, still more preferably not less than 60%, more preferably not more than 75%, and still more preferably not more than 70%. If the content of S in the amorphous glass is less than 50%, vitrification is less likely to occur. On the other hand, if the content of S in the amorphous glass is more than 80%, the weather resistance of the glass decreases, which may restrict the use conditions of the immersion diffraction element 101.

In the above amorphous glass, the content of Sb is, in terms of percent by mole, more preferably not less than 5%, still more preferably not less than 10%, more preferably not more than 35%, and still more preferably not more than 33%. If the amorphous glass is free of Sb or the content of Sb therein is more than 40%, vitrification may be less likely to occur.

In the above amorphous glass, the content of Ge is, in terms of percent by mole, more preferably not less than 2%, still more preferably not less than 4%, and more preferably not more than 15%. If the glass is free of Ge, vitrification is less likely to occur. On the other hand, if the content of Ge in the amorphous glass is more than 18%, Ge-based crystals are precipitated from the glass, which may make it difficult to achieve a refractive index and an internal transmittance meeting the properties of the immersion diffraction element 101, and the viscosity of glass in mold press forming increases, which may deteriorate the shape followability of the diffraction portion 104 to a press mold 110 to be described later.

In the above amorphous glass, the content of Sn is, in terms of percent by mole, more preferably not less than 1%, still more preferably not less than 5%, more preferably not more than 15%, and still more preferably not more than 10%. The component Sn in the amorphous glass is a component accelerating vitrification. However, if the content of Sn in the amorphous glass is more than 20%, vitrification is less likely to occur.

In the above amorphous glass, the content of Bi is, in terms of percent by mole, more preferably not less than 0.5%, still more preferably not less than 2%, more preferably not more than 10%, and still more preferably not more than 8%. The component Bi in the amorphous glass is a component that reduces the energy necessary to vitrify a source material during glass melting. However, if the content of Bi in the amorphous glass is more than 20%, Bi-based crystals are precipitated from the glass, which makes it difficult to achieve an internal transmittance meeting the properties of the immersion diffraction element 101.

The refractive index of the amorphous glass constituting the diffraction portion 104 at a wavelength of 10 μm is preferably 3.0 or more, more preferably 3.1 or more, and still more preferably 3.2 or more. When the refractive index of the amorphous glass is not less than the above lower limit, the immersion diffraction element 101 can be further reduced in size. The upper limit of the refractive index of the amorphous glass is not particularly limited, but may be, for example, not more than 4.1 judging from the nature of the material.

The density of the amorphous glass constituting the diffraction portion 104 is preferably 6.5 g/cm³ or less, more preferably 6.3 g/cm³ or less, and still more preferably 6.0 g/cm³ or less. When the density of the amorphous glass is within the above range, the immersion diffraction element 101 can be further reduced in weight.

Furthermore, as for the amorphous glass constituting the diffraction portion 104, its internal transmittance in an infrared wavelength range of 7.0 μm to 11.0 μm is preferably 80% or more, more preferably 85% or more, and still more preferably 90% or more. In this case, a desired optical performance can be more certainly achieved. The upper limit of the internal transmittance in an infrared wavelength range of 7.0 μm to 11.0 μm may be, for example, 99.5%. The internal transmittance used herein refers to that when the thickness is 2.0 mm.

As shown in FIGS. 15 and 16, in this embodiment, the troughs 104c1 of the recessed areas 104c of the diffraction portion 104 preferably have a more acute shape than the crests 104d1 of the raised areas 104d. Significant effects on the properties of the immersion diffraction element 101 are given by the fourth faces 104a and the troughs 104c1 of the recessed areas 104c. Therefore, when the troughs 104c1 of the recessed areas 104c have a more acute shape than the crests 104d1 of the raised areas 104d, i.e., when the value obtained by dividing R104c1 by R104d1 is preferably 2.0 or less and more preferably 1.0 or less where R104c1 represents the corner R (radius, μm) of the troughs 104c1 of the recessed areas 104c and R104d1 represents the corner R (radius, μm) of the crests 104d1 of the raised areas 104d, the diffraction efficiency of the immersion diffraction element 101 can be further increased. The value of R104c1 is preferably 0.1 μm to 10 μm and the value of R104d1 is preferably 5 μm to 20 μm.

Furthermore, the angle θ3 formed by the fourth face 104a and the fifth face 104b defining the trough 104c1 of each of the recessed areas 104c is preferably not less than 60°, more preferably not less than 65°, still more preferably not less than 70°, particularly preferably not less than 80°, preferably not more than 120°, more preferably not more than 115°, still more preferably not more than 110°, and particularly preferably not more than 100°. The angle θ3 formed by the fourth face 104a and the fifth face 104b defining the trough 104c1 of each of the recessed areas 104c is preferably 90°±1° and particularly preferably 90°. In this case, the diffraction efficiency of the immersion diffraction element 101 can be further increased.

Hereinafter, a description will be given of an example of a production method of an immersion diffraction element 101.

### (Production Method)

### Preparing Step;

In a production method according to this embodiment, a prism and amorphous glass are first prepared. As the prism, the same material as the above-described prism portion 102 can be used. As the amorphous glass, the same material as the amorphous glass constituting the above-described diffraction portion 104 can be used. The glass prepared as the amorphous glass is, for example, a base material glass made of a chalcogenide glass that has a glass composition of, in terms of percent by mole, 60% of S, 30% of Sb, 5% of Ge, and 5% of Sn or a chalcogenide glass that has a glass composition of, in terms of percent by mole, 70% of Te, 25% of Ge, and 5% of Ga.

### Diffraction Portion Forming Step;

Next, the amorphous glass is mold press formed to form a diffraction portion 104.

In the present invention, in forming recessed and raised areas of the diffraction portion 104, the amorphous glass is preferably mold press formed so that the troughs 104c1 of the recessed areas 104c have a more acute shape than the crests 104d1 of the raised areas 104d. As shown in FIG. 15, in the resultant diffraction portion 104, the fourth faces 104a and the troughs 104c1 of the recessed areas 104c have significant effects on the properties of the immersion diffraction element 101. Therefore, when the troughs 104c1 of the recessed areas 104c have a more acute shape than the crests 104d1 of the raised areas 104d, i.e., when the value obtained by dividing R104c1 by R104d1 is preferably 2.0 or less and more preferably 1.0 or less where R104c1 represents the corner R of the troughs 104c1 of the recessed areas 104c and R104d1 represents the corner R of the crests 104d1 of the raised areas 104d, the diffraction efficiency of the immersion diffraction element 101 can be further increased. The value of R104c1 is preferably 0.1 μm to 10 μm and the value of R104d1 is preferably 5 μm to 20 μm.

Furthermore, in the present invention, in forming recessed and raised areas of the diffraction portion 104, the amorphous glass is preferably mold press formed so that the angle θ3 formed by the fourth face 104a and the fifth face 104b defining the trough 104c1 of each of the recessed areas 104c is not less than 60° and not more than 120°. The angle θ3 formed by the fourth face 104a and the fifth face 104b defining the trough 104c1 of each of the recessed areas 104c is more preferably not less than 60°, still more preferably not less than 65°, more preferably not more than 120°, and still more preferably not more than 115°. The angle θ3 formed by the fourth face 104a and the fifth face 104b defining the trough 104c1 of each of the recessed areas 104c is preferably 90°±1° and more preferably 90°. In this case, the diffraction efficiency of the immersion diffraction element 101 can be further increased.

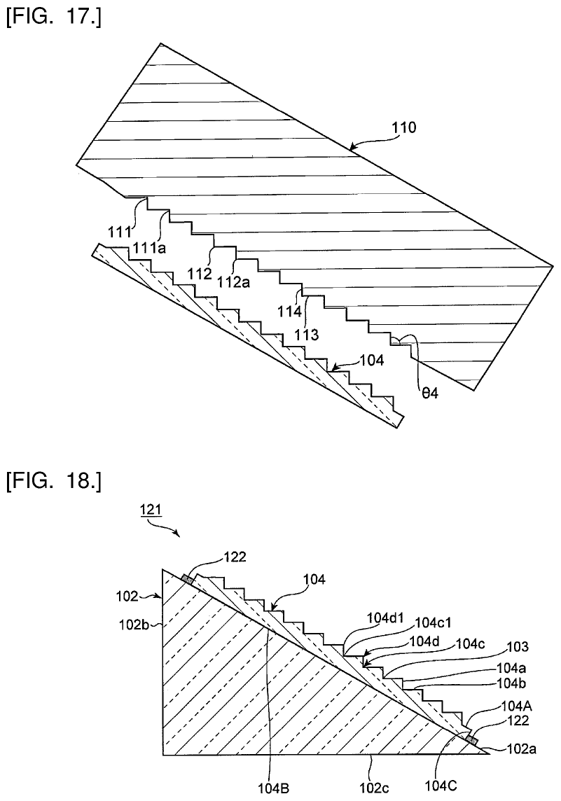

FIG. 17 is a schematic cross-sectional view for illustrating a press mold for use in a method for producing an immersion diffraction element according to the fourth embodiment of the present invention.

As shown in FIG. 17, a press mold 110 has a counter-shape to the recessed and raised areas of the diffraction portion 104. In the press mold 110, the crests 112a of its raised areas 112 preferably have a more acute shape than the troughs 111a of its recessed areas 111 and, specifically, the value obtained by dividing R112a by R111a is preferably 10.0 or less and more preferably 8.0 or less where R112a represents the corner R of the crests 112a of the raised areas 112 and R111a represents the corner R of the troughs 111a of the recessed areas 111. When the amorphous glass is mold press formed using this press mold 110, the value obtained by dividing R104c1 by R104d1 in relation to the diffraction portion 104 can be more certainly led to 10.0 or less, preferably 2.0 or less, and more preferably 1.0 or less and, thus, the diffraction efficiency of the immersion diffraction element 101 can be further increased. The value of R111a is preferably 1 μm to 20 μm and the value of R112a is preferably 0.05 μm to 10 μm.

Furthermore, in the press mold 110, the angle θ4 formed by a sixth face 113 and a seventh face 114 defining the crest 112a of each of the raised areas 112 is preferably not less than 60°, more preferably not less than 65°, still more preferably not less than 70°, particularly preferably not less than 80°, preferably not more than 120°, more preferably not more than 115°, still more preferably not more than 110°, and particularly preferably not more than 100°. The angle θ4 formed by the sixth face 113 and the seventh face 114 defining the crest 112a of each of the raised areas 112 is preferably 90°±1° and more preferably 90°. When the amorphous glass is mold press formed using this press mold 110, the angle formed by the fourth face 104a and the fifth face 104b defining the trough 104c1 of each of the recessed areas 104c can be adjusted within the above-described preferred range and, thus, the diffraction efficiency of the immersion diffraction element 101 can be further increased.

The material for the press mold 110 is not particularly limited, but, for example, an ultrahard material, STAVAX, HPM38 or so on can be used. A press mold plated with a material containing nickel may be used as the press mold 110.

In the present invention, in forming the diffraction portion 104, the amorphous glass is preferably mold press formed at a temperature of not lower than the glass transition temperature of the amorphous glass plus 5° C. and not higher than the glass transition temperature plus 50° C. The mold press forming temperature of the amorphous glass is more preferably not lower than the glass transition temperature of the amorphous glass plus 10° C. and not higher than the glass transition temperature plus 45° C., and still more preferably not lower than the glass transition temperature of the amorphous glass plus 15° C. and not higher than the glass transition temperature plus 40° C.

The glass transition point of the above amorphous glass is preferably not lower than 140° C., more preferably not lower than 145° C., still more preferably not lower than 150° C., preferably not higher than 250° C., more preferably not higher than 245° C., and still more preferably not higher than 240° C.

When mold press formed at such a temperature as described above, the amorphous glass can be pressed at a lower temperature and, therefore, heat variation is further less likely to occur even when a large-sized amorphous glass is molded. In addition, heat distortion that may cause a dimension change can be further less likely to occur.

Although a press mold plated with nickel and phosphorus may be difficult to use at high temperatures because of crystallization, it can be suitably used upon pressing at such a low temperature as described above. With the use of a press mold plated with nickel and phosphorus, the surface specularity for the press mold can be more easily obtained and the surface precision of mold press forming can be thus further increased, which further increases the degrees of freedom in the design of the diffraction portion 104. Although herein a press mold plated with a material containing nickel is described as an example, the type of plating is not limited to this and examples that can be used include plating with nickel and molybdenum and plating with nickel and tungsten.

### Bonding Step;

Next, the prism and the diffraction portion 104 are bonded together. The prism and the diffraction portion 104 can be bonded together, for example, by a room-temperature bonding method, such as optical contact or surface activated bonding. The prism and the diffraction portion 104 may be bonded together by soldering as in a fifth embodiment to be described later.

In the production method according to this embodiment, an immersion diffraction element 101 can be easily produced by mold press forming the amorphous glass to form a diffraction portion 104 and bonding a prism and the diffraction portion 104 together. In addition, because amorphous glass for use in forming the diffraction portion 104 can be easily subjected to imprinting processing and is free from restrictions on processible shape due to crystal orientation, the degrees of freedom in the design of the diffraction portion 104 can be increased. Accordingly, the production method according to this embodiment can increase the optical degrees of freedom of the immersion diffraction element 101.

### Fifth Embodiment

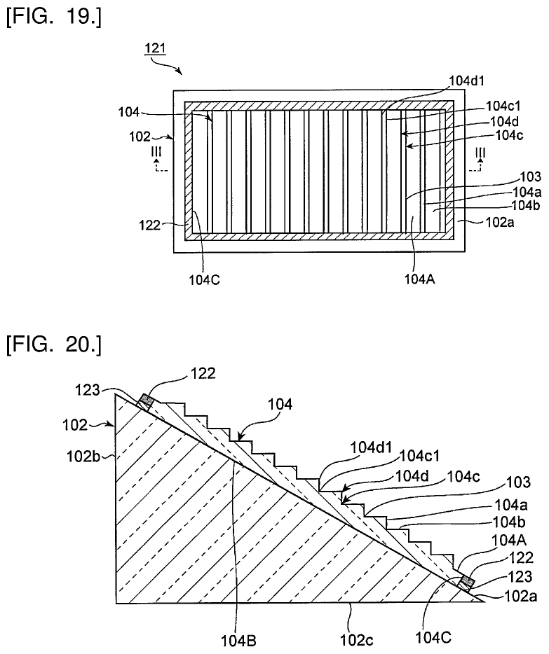

FIG. 18 is a schematic cross-sectional view showing an immersion diffraction element according to a fifth embodiment of the present invention. Furthermore, FIG. 19 is a schematic plan view showing a diffraction surface of the immersion diffraction element according to the fifth embodiment of the present invention. FIG. 18 is a schematic cross-sectional view taken along the line III-III in FIG. 19.

As shown in FIGS. 18 and 19, in an immersion diffraction element 121, a diffraction portion 104 has a diffraction optical surface 104A, a bottom surface 104b opposed to the diffraction optical surface 104A, and a side surface 104c connected to the diffraction optical surface 104A and the bottom surface 104b. Furthermore, in the immersion diffraction element 121, a solder 122 is provided across the side surface 104c of the diffraction portion 104 and a prism portion 102. The prism portion 102 and the diffraction portion 104 are bonded together by the solder 122.

The melting point of the solder 122 is lower than the glass transition point of amorphous glass constituting the diffraction portion 104. Therefore, the shape stability of the diffraction portion 104 and the positional accuracy can be further increased.

The absolute value of a difference in coefficient of thermal expansion between the solder 122 and the amorphous glass constituting the diffraction portion 104 is preferably 170×10⁻⁷/° C. or less, more preferably 160×10⁻⁷/° C. or less, and still more preferably 150×10⁻⁷/° C. or less. In this case, the bonding strength between the prism portion 102 and the diffraction portion 104 can be further increased. The lower limit of the absolute value of a difference in coefficient of thermal expansion between the solder 122 and the amorphous glass constituting the diffraction portion 104 is not particularly limited, but may be, for example, 50×10⁻⁷/° C.

The solder 122 preferably contains In, Sn or Bi. Specifically, an example of the material for the solder 122 is a material in which a Su-Bi—In ternary alloy contains an element selected from the group consisting of Ag, Cu, Ni, Zn, and Sb.

The thickness of the solder 122 is not particularly limited and may be, for example, not less than 10 μm and not more than 100 km.

As shown in FIG. 19, the solder 122 is preferably provided around the entire side surface 104c of the diffraction portion 104. In this case, the prism portion 102 and the diffraction portion 104 can be more certainly bonded together. However, the solder 122 is sufficient to be provided at least partially around the side surface 104c of the diffraction portion 104.

Alternatively, as in a modification shown in FIG. 20, the immersion diffraction element 121 may further include a first underlying film 123 provided on a first principal surface 102a of the prism portion 102 and the solder 122 may be provided across the side surface 104c of the diffraction portion 104 and the first underlying film 123. The first underlying film 123 is preferably provided to surround the diffraction portion 104 when the diffraction optical surface 104A is viewed in plan. In this case, the prism portion 102 and the diffraction portion 104 can be more certainly bonded together. The first underlying film 123 is sufficient to be provided at least partially around the side surface 104c of the diffraction portion 104.

The material for the first underlying film 123 is not particularly limited and, for example, Si, Ti, Cu, Ni, Cr, Pt, Pd or so on can be used.

The thickness of the first underlying film 123 is not particularly limited and may be, for example, not less than 0.1 μm and not more than 20 μm.

Also in the immersion diffraction element 121 according to the fifth embodiment, the diffraction portion 104 is made of amorphous glass. Therefore, the immersion diffraction element 121 can be easily produced and can increase the degrees of freedom in the design of the diffraction portion 104.

### Sixth Embodiment

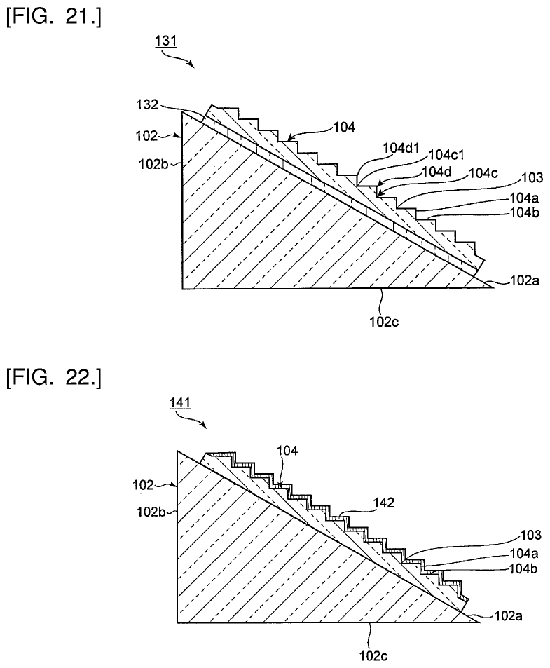

FIG. 21 is a schematic cross-sectional view showing an immersion diffraction element according to a sixth embodiment of the present invention.

As shown in FIG. 21, in an immersion diffraction element 131, a diffraction portion 104 is provided on a first principal surface 102a of a prism portion 102 with a second underlying film 132 in between. In this case, the material of the second underlying film 132 is preferably the same material as that of the prism portion 102. Therefore, for example, when the prism portion 102 is made of Si, Si is preferably used as the second underlying film 132. When the prism portion 102 is made of GaAs, GaAs is preferably used as the second underlying film 132. The thickness of the second underlying film 132 is not particularly limited and may be, for example, not less than 0.1 μm and not more than 20 μm. The rest is the same as in the fourth embodiment.

Also in the immersion diffraction element 131 according to the sixth embodiment, the diffraction portion 104 is made of amorphous glass. Therefore, the immersion diffraction element 131 can be easily produced and can increase the degrees of freedom in the design of the diffraction portion 104.

Furthermore, as in the immersion diffraction element 131, a diffraction portion 104 may be provided on the first principal surface 102a of the prism portion 102 with a second underlying film 132 in between. Thus, the prism portion 102 and the diffraction portion 104 can be more certainly bonded together.

### Seventh Embodiment

FIG. 22 is a schematic cross-sectional view showing an immersion diffraction element according to a seventh embodiment of the present invention.

As shown in FIG. 22, in an immersion diffraction element 141, the surface of a diffraction portion 104 is covered with a reflective film 142. More specifically, the reflective film 142 covers fourth faces 104a and fifth faces 104b of the diffraction portion 104.

The material for the reflective film 142 is not particularly limited, but Au or so on can be used. An appropriate dielectric multi-layer may be used as the reflective film 142. The thickness of the reflective film 142 may be, for example, not less than 1 μm and not more than 10 μm. The reflective film 142 can be formed, for example, by a vapor deposition method or a sputtering method.

The rest is the same as in the fourth embodiment.

Also in the immersion diffraction element 141 according to the seventh embodiment, the diffraction portion 104 is made of amorphous glass. Therefore, the immersion diffraction element 141 can be easily produced and can increase the degrees of freedom in the design of the diffraction portion 104.

Furthermore, as in the immersion diffraction element 141, the surface of the diffraction portion 104 may be covered with a reflective film 142. In this case, light having entered the prism portion 102 can be more certainly reflected at the diffraction portion 104 and can be more certainly spectrally separated.

### Eighth Embodiment

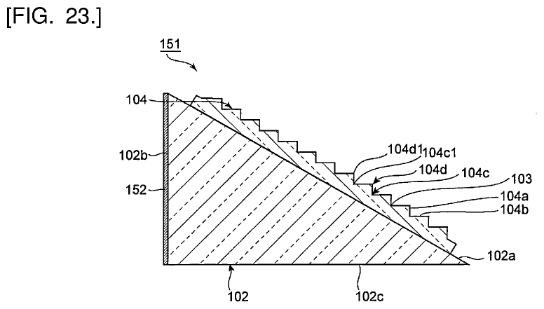

FIG. 23 is a schematic cross-sectional view showing an immersion diffraction element according to an eighth embodiment of the present invention.

As shown in FIG. 23, in an immersion diffraction element 151, an antireflection film 152 is provided on a second principal surface 102b of a prism portion 102.

The antireflection film 152 is preferably made of, for example, at least one selected from among Ge, Si, fluorides, ZnSe, ZnS, and diamond-like carbon. The antireflection film 152 can be formed, for example, by a vapor deposition method or a sputtering method. The thickness of the antireflection film 152 may be, for example, not less than 1.0 μm and not more than 5.0 μm. The rest is the same as in the fourth embodiment.

Also in the immersion diffraction element 151 according to the eighth embodiment, the diffraction portion 104 is made of amorphous glass. Therefore, the immersion diffraction element 151 can be easily produced and can increase the degrees of freedom in the design of the diffraction portion 104.

Furthermore, as in the immersion diffraction element 151, an antireflection film 152 may be provided on the second principal surface 102b of the prism portion 102. The second principal surface 102b of the prism portion 102 is a light entrance portion of the immersion diffraction element 151. Therefore, when the antireflection film 152 is provided on the light entrance portion, incident light can be less likely to be reflected there. Thus, in this case, the light use efficiency of the immersion diffraction element 151 can be further increased.

### REFERENCE SIGNS LIST

1, 21, 31, 101, 121, 131, 141, 151 . . . immersion diffraction element
2, 102 . . . prism portion
2a to 2c . . . first to third faces
3, 103 . . . diffraction groove
4, 104 . . . diffraction portion
4a, 104a . . . fourth face
4b, 104b . . . fifth face
4c, 11, 104c, 111 . . . recessed area
4c1, 11a, 104c1, 111a . . . trough
4d, 12, 104d, 112 . . . raised area
4d1, 12a, 104d1, 112a . . . crest
10, 110 . . . press mold
13, 113 . . . sixth face
14, 114 . . . seventh face
22, 142 . . . reflective film
32, 152 . . . antireflection film
A, B . . . light
R4c1, R104c1 . . . corner R of trough of recessed area
R4d1, R104d1 . . . corner R of crest of raised area
R11a, R111a . . . corner R of trough of recessed area
R12a, R112a . . . corner R of crest of raised area
θ1, θ2, θ3, θ4 . . . angle
102a . . . first principal surface
102b . . . second principal surface
102c . . . third principal surface
104A . . . diffraction optical surface
104B . . . bottom surface
104c . . . side surface
122 . . . solder
123 . . . first underlying film
132 . . . second underlying film

1: An immersion diffraction element comprising a prism portion and a diffraction portion, the prism portion and the diffraction portion being made of amorphous glass.

2: An immersion diffraction element comprising:
a prism portion having a first principal surface, a second principal surface, and a third principal surface; and
a diffraction portion provided on the first principal surface of the prism portion and made of amorphous glass.

3: The immersion diffraction element according to claim 1, wherein the amorphous glass has a refractive index of 3.0 or more at a wavelength of 10 μm.

4: The immersion diffraction element according to claim 1, wherein the amorphous glass is chalcogenide glass.

5: The immersion diffraction element according to claim 1, wherein the amorphous glass contains, in terms of percent by mole, 4% to 80% Te, 0% to 50% Ge (exclusive of 0%), and 0% to 20% Ga.

6: The immersion diffraction element according to claim 1, wherein the amorphous glass contains, in terms of percent by mole, 50% to 80% S, 0% to 40% Sb (exclusive of 0%), 0% to 18% Ge (exclusive of 0%), 0% to 20% Sn, and 0% to 20% Bi.

7: The immersion diffraction element according to claim 1, wherein the diffraction portion has a value of 2.0 or less obtained by dividing a corner R of a trough of a recessed area by a corner R of a crest of a raised area.

8: The immersion diffraction element according to claim 7, wherein an angle formed by faces defining the trough of the recessed area is not less than 60° and not more than 120°.

9: The immersion diffraction element according to claim 1, wherein a surface of the diffraction portion is covered with a reflective film.

10: The immersion diffraction element according to claim 9, wherein the reflective film is made of Au.

11: The immersion diffraction element according to claim 2, wherein an absolute value of a difference in refractive index at a wavelength of 10 μm between a material constituting the prism portion and the amorphous glass constituting the diffraction portion is 0.3 or less.

12: The immersion diffraction element according to claim 2, wherein an absolute value of a difference in coefficient of thermal expansion between a material constituting the prism portion and the amorphous glass constituting the diffraction portion is 150×10⁻⁷/° C. or less.

13: The immersion diffraction element according to claim 2, wherein the prism portion is made of Si.

14: The immersion diffraction element according to claim 2, wherein:
the diffraction portion has a diffraction optical surface, a bottom surface opposed to the diffraction optical surface, and a side surface connected to the diffraction optical surface and the bottom surface; and
the diffraction portion and the prism portion are bonded together, without soldering between the first principal surface of the prism portion and the bottom surface of the diffraction portion, by a solder provided across the side surface of the diffraction portion and the prism portion and the solder has a melting point lower than a glass transition point of the amorphous glass.

15: The immersion diffraction element according to claim 14, wherein an absolute value of a difference in coefficient of thermal expansion between the solder and the amorphous glass is 170×10⁻⁷/° C. or less.

16: The immersion diffraction element according to claim 14, wherein the solder contains In, Sn or Bi.

17: The immersion diffraction element according to claim 14, wherein the solder is provided around the entire side surface of the diffraction portion.

18: The immersion diffraction element according to claim 14,
further comprising a first underlying film provided on the first principal surface of the prism portion,
wherein the solder is provided across the side surface of the diffraction portion and the first underlying film.

19: The immersion diffraction element according to claim 18, wherein the first underlying film is provided to surround the diffraction portion when viewed from a direction where the diffraction optical surface and the bottom surface are opposed to each other.

20: The immersion diffraction element according to claim 18, wherein the first underlying film is provided outside a region between the diffraction portion and the prism portion.

21: The immersion diffraction element according to claim 2, wherein the diffraction portion is provided on the first principal surface of the prism portion with a second underlying film in between.

22: The immersion diffraction element according to claim 21, wherein the second underlying film is made of Si.

23: A method for producing an immersion diffraction element, the method comprising the steps of:
preparing amorphous glass; and
mold press forming the amorphous glass to form a diffraction portion.

24: A method for producing an immersion diffraction element, the method comprising the steps of:
preparing a prism and amorphous glass;
mold press forming the amorphous glass to form a diffraction portion; and
bonding the prism and the diffraction portion together.

25: The method for producing an immersion diffraction element according to claim 23, wherein in forming a recessed area and a raised area of the diffraction portion, the amorphous glass is mold press formed so that a value obtained by dividing a corner R of a trough of the recessed area by a corner R of a crest of the raised area is 2.0 or less.

26: The method for producing an immersion diffraction element according to claim 25, wherein in forming the recessed area and the raised area of the diffraction portion, the amorphous glass is mold press formed so that an angle formed by faces defining the trough of the recessed area is not less than 60° and not more than 120°.

27: The method for producing an immersion diffraction element according to claim 23, wherein in forming a recessed area and a raised area of the diffraction portion, the amorphous glass is mold press formed using a press mold which has a counter-shape to the recessed area and the raised area of the diffraction portion and whose value obtained by dividing a corner R of a crest of a raised area by a corner R of a trough of a recessed area is 10.0 or less.

28: The method for producing an immersion diffraction element according to claim 27, wherein the amorphous glass is mold press formed using a press mold having an angle of not less than 60° and not more than 120° formed by faces defining the trough of the recessed area.

29: The method for producing an immersion diffraction element according to claim 23, wherein the amorphous glass has a glass transition point of not lower than 140° C. and not higher than 250° C.

30: The method for producing an immersion diffraction element according to claim 23, wherein in forming the diffraction portion, the amorphous glass is mold press formed at a temperature of not lower than a glass transition temperature of the amorphous glass plus 5° C. and not higher than the glass transition temperature plus 50° C.

31: The method for producing an immersion diffraction element according to claim 23, wherein in forming the diffraction portion, the amorphous glass is mold press formed using a press mold plated with nickel and phosphorus.

32: The method for producing an immersion diffraction element according to claim 24, wherein in the step of bonding the prism and the diffraction portion together, the diffraction portion is disposed on a first principal surface of the prism, a solder is provided across a side surface of the diffraction portion and the prism, and the prism and the diffraction portion are bonded with the solder.
